(19) United States
(12) Patent Application Publication
(10) Pub. No.: US 2006/0194663 A1
(43) Pub. Date: Aug. 31, 2006

(54) Pulley for clutchless compressor

(75) Inventor: Masayuki Kouno, Saitama (JP)

Correspondence Address: RADER FISHMAN & GRAUER PLLC, LION BUILDING, 1233 20TH STREET N.W., SUITE 501, WASHINGTON, DC, 20036, US

(73) Assignee: Valeo Thermal Systems Japan Corporation

(21) Appl. No.: 11/358,152

(22) Filed: Feb. 22, 2006

(30) Foreign Application Priority Data
Feb. 25, 2005 (JP) 2005-051503

(51) Int. Cl. F16H 55/36; F16D 3/00; F16H 61/00

(52) U.S. Cl. 474/166; 474/70; 474/94

(57) ABSTRACT

This invention has an object to reduce the pulley manufacturing costs by eliminating a time-wasting step when bonding an elastic member of a damper unit. In a pulley for a clutchless compressor comprising a hub unit (30) fixed to a drive shaft of the compressor and a damper unit (31) disposed between a member caused to rotate in response to a drive force imparted from a drive source and the hub unit (30) to achieve a buffer effect via an elastic member (42), the hub unit (30) and the damper unit (31) are formed as separate members independent of each other and engaging means (38) and (44) used to engage the hub unit (30) and the damper unit (31) with each other are included.

### CROSS-REFERENCE TO RELATED APPLICATIONS

This application is based upon and claims the benefit of priority from the prior Japanese Patent Application No. 2005-051503, filed on Feb. 25, 2005 the entire contents of which are incorporated herein by reference.

### TECHNICAL FIELD

The present invention relates to a pulley mounted at a drive shaft of a clutchless compressor in an automotive air-conditioning system, and more specifically, it relates to a structure adopted in a damper assembly to achieve a buffer effect.

### BACKGROUND ART

A clutchless compressor includes a mechanism that is linked with a drive source such as an engine at all times and adjusts the coolant compression ratio and thus, the clutchless compressor can be driven in direct response to the control executed in the air-conditioning system without having to utilize an electromagnetic clutch or the like. If a problem such as a seizure occurs at a sliding portion or a rotating portion, e.g., a piston or a bearing, inside the compression space in the clutchless compressor which remains linked with the drive source at all times as described above, the drive source may be subjected to an excessive torque that could lead to a serious accident. This issue is addressed in a structure disclosed in the related art, which includes a breaking means that is disposed at the pulley mounted at the drive shaft of the compressor and breaks in an emergency situation, i.e., when a torque equal to or greater than a predetermined level occurs, so as to break the linkage between the drive source and the compressor (see Japanese Unexamined Patent Publication No. 2002-372130).

In addition, as shown in FIG. 15, the clutchless compressor pulley in the related art includes an outer ring 101 fixed to a rim 100 that rotates in response to a drive force imparted from a drive source such as an engine E, a rubber member 103 filling and bonded in the space between the outer ring 101 and an inner ring 102 disposed at an inner position relative to the outer ring 101 and a hub unit 105 fixed onto the inner ring 102 and the drive shaft 104 of the compressor, all formed as integrated parts thereof.

### DISCLOSURE OF THE INVENTION

As described above, a hub member 106 that includes an integrated unit made up with the hub unit 105 and the inner ring 102 is used in the pulley in the related art. The hub member 106, requiring a highly specialized machining technology to produce, is normally manufactured by a special manufacturer rather than by the manufacturer (factory or company) where the rubber member 103 is bonded. In particular, the hub member 106 to include a breaking means as described above is more likely to be contracted out to a manufacturer with specific expertise. Under normal circumstances, the entire hub member 106 will be coated with an anti-rust paint when it is ready to be shipped. For this reason, before the rubber member 103 can be bonded and vulcanized at the other manufacturer, the paint coating on the hub member 106 needs to be partially or entirely stripped. Then, upon completing the bonding process, the hub member needs to be coated with a paint again to regain an anti-rust property. The considerable pulley manufacturing costs are in part attributable to such a time wasting procedure.

Accordingly, an object of the present invention is to reduce the pulley manufacturing costs by eliminating the time wasting processes when bonding the elastic member.

In order to achieve the object described above, the present invention provides a pulley for a clutchless compressor, comprising a hub unit fixed to a drive shaft of the compressor and a damper unit disposed between a member that rotates in response to a drive force imparted from a drive source and the hub unit to achieve a buffer effect via an elastic member thereof, characterized in that the hub unit and the damper unit are formed as separate members independent of each other and that it includes an engaging means for engaging the hub unit and the damper unit to each other.

According to the present invention, the hub unit and the damper unit, which are initially manufactured as separate members, are integrated later via the engaging means, thereby forming a single damper assembly. Since this eliminates the need to strip the paint coated on the hub unit when bonding the elastic member as in the related art, the time wasting manufacturing step in the related art is eliminated, which, in turn, lowers the pulley manufacturing cost.

In addition, it is desirable that the damper unit in the structure disclosed in claim 1 include an outer ring fixed to the member which rotates in response to the drive force imparted from the drive source, an inner ring disposed further inward relative to the outer ring and the elastic member filling and bonded in the space between the outer ring and the inner ring.

While the inner ring is part of the hub unit in the pulley in the related art, the inner ring and the outer ring are integrated via the elastic member constituted of rubber or the like in the structure according to the present invention. This means that the damper unit can be manufactured as an independent member.

It is desirable that the engaging means in the structure disclosed in claim 2 be constituted with a projected portion and an indented portion formed at the hub unit and the inner ring to engage with each other.

For instance, the projected portion may be formed at the hub unit and the indented portion may be formed at the inner ring to facilitate a reliable assembly of the hub unit and the damper unit. Specific shapes that may be adopted at the projected portion and the indented portion should be determined as appropriate and several ideal examples are described in reference to the embodiments later. The object of the present invention may also be achieved with an indented portion formed at the hub unit and a projected portion formed at the inner ring.

Furthermore, the elastic member in the structure disclosed in claim 2 may be provided on the inside of the inner ring. The engaging means in the structure disclosed in claim 4 should be constituted with a projected portion and an indented portion formed at the hub unit and the portion of the elastic member present on the inside of the inner ring to engage with each other.

When adopting the structure described above in which the elastic member of the damper unit is disposed so as to range over onto the inside of the inner ring (toward the hub unit or the drive shaft) the part of the damper unit disposed at the closest position to the hub unit is the elastic member. Thus, it is structurally desirable that if, for instance, the projected portion is formed at the hub unit, the indented portion to engage with the projected portion be formed at the elastic member. This structure improves the ease of assembly of the hub unit and the damper unit via the elastic force imparted at the elastic member, and at the same time, improves the buffer effect achieved with the entire damper assembly. It is to be noted that specific forms to be adopted at the projected portion and the indented portion should be selected as appropriate and that the object of the present invention may also be achieved with an indented portion formed at the hub unit and a projected portion formed at the elastic member.

In addition, the structures disclosed in claims 1 through 5 are ideal when adopted in conjunction with a hub unit that includes a breaking means that breaks when a torque equal to or greater than a predetermined level is applied.

Special machining expertise is required when forming a breaking means at the hub unit, and thus, production of the hub unit is often contracted out to a manufacturer with specific expertise. Accordingly, the present invention, which provides the hub unit and the damper unit as components independent of each other, will prove particularly effective under such circumstances.

### BRIEF DESCRIPTION OF THE DRAWINGS

FIG. 1 is an example of a structure that may be adopted in a clutchless compressor that includes the pulley according to the present invention

FIG. 2 is a perspective showing the structure of the damper assembly achieved in embodiment 1 of the present invention

FIG. 3 is a top view showing the structure of the damper assembly achieved in embodiment 1

FIG. 4 is a partial sectional view showing the structure of the damper unit in the damper assembly achieved in embodiment 1

FIG. 5 is a partial sectional view showing the structure of the damper unit in the damper assembly achieved in embodiment 2 of the present invention

FIG. 6 is a perspective showing the structure of the hub unit in the damper assembly achieved in embodiment 3 of the present invention

FIG. 7 is a perspective showing the structure of the damper assembly achieved in embodiment 4 of the present invention

FIG. 8 is the structure of the projected portions in the damper assembly achieved in embodiment 4

FIG. 9(a) is the structure of the small projections in the damper assembly achieved in embodiment 4

FIG. 9(b) is a small projection and the corresponding small indentation in an engaged state at the pulley achieved in embodiment 4

FIG. 10 is a perspective showing the structure of the damper assembly achieved in embodiment 5 of the present invention

FIG. 11 is the structures of the inner ring and the indented portions covered with a rubber layer in the damper assembly achieved in embodiment 5

FIG. 12 is the structures of the inner ring and the indented portions not covered with the rubber layer in the damper assembly achieved in embodiment 5

FIG. 13 is a partial sectional view of a projected portion and the ccorg indented portion in an engaged state in the damper assembly achieved in embodiment 5

FIG. 14 is a partial perspective showing the structures of the projected portions and the indented portions in the damper assembly achieved in embodiment 6 of the present invention

FIG. 15 is a partial sectional view showing the structure of a pulley for a clutchless compressor in the related art

### BEST MODE FOR CARRYING OUT THE INVENTION

The following is an explanation of embodiments of the present invention, given in reference to the attached drawings. It is to be noted that components achieving identical or similar functions in different embodiments are not repeatedly explained.

### Embodiment 1

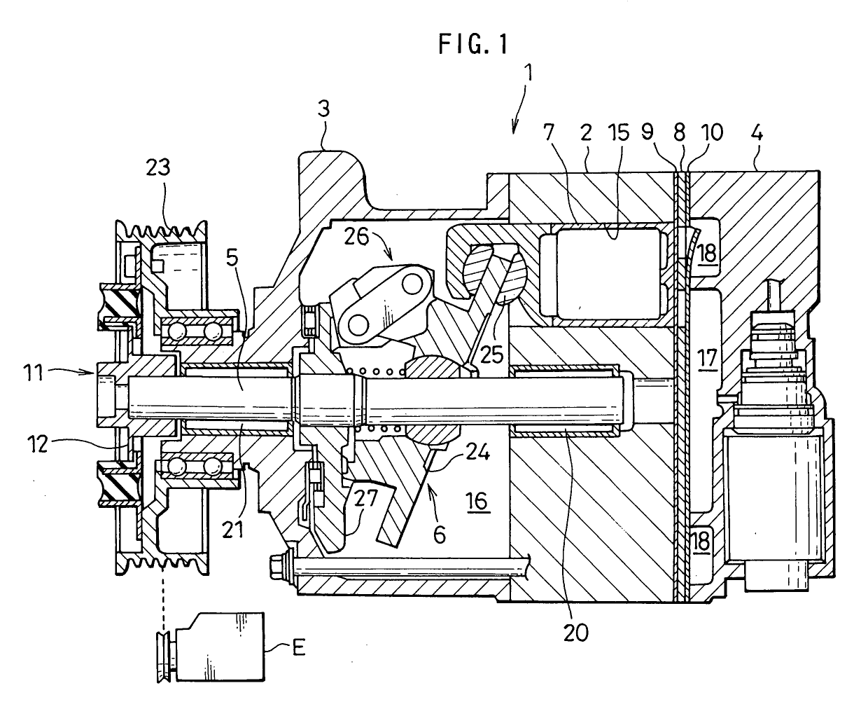

A clutchless compressor (hereafter simply referred to as a compressor) 1 in FIG. 1 comprises a cylinder block 2, a front head 3, a rear head 4, a drive shaft 5, a swashplate mechanism 6, pistons 7, a valve plate 8, an intake valve 9, a delivery valve 10, a pulley for a clutchless compressor (hereafter simply referred to as a pulley) 11 and the like. A plurality of cylinders 15 are formed at the cylinder block 2 and the pistons 7 are slidably disposed, one inside each cylinder 15. The front head 3, which seals the cylinder block 2 at one end thereof, includes a crank chamber 16 formed therein. The rear head 4, which seals the cylinder block 2 at the other end thereof, includes an intake chamber 17 and a delivery chamber 18 formed therein. The drive shaft 5 is rotatably held at bearings 20 and 21 respectively disposed at the cylinder block 2 and the front head 3, and the front end of the drive shaft 5 projects out through the front head 3. The swashplate mechanism 6, which is disposed inside the crank chamber 16, is constituted with a swashplate 24, shoes 25, a swashplate angle adjusting unit 26, a thrust flange 27 and the like. It is of the known art, capable of converting the rotational force of the drive shaft 5 to reciprocal motion of the pistons 7 with the angle of the swashplate 24 adjusted based upon the crank chamber pressure, the delivery pressure, the intake pressure and the like. The pulley 11 includes a damper assembly 12 to be detailed later, which is fixed onto the front end of the drive shaft 5, and a rim 23 caused to rotate by the drive force imparted from an engine E.

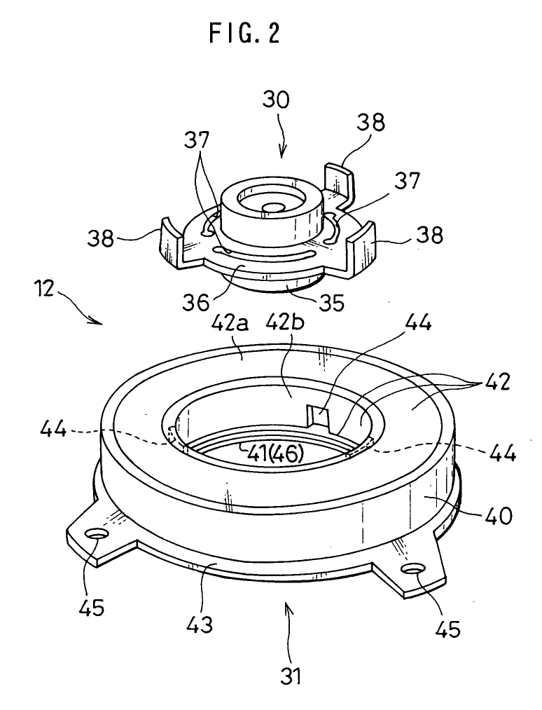

As shown in FIGS. 2 and 3, the damper assembly 12 according to the present invention includes a hub unit 30 and a damper unit 31. FIG. 3 shows the hub unit 30 and the damper unit 31 in an assembled state. The hub unit 30 in the embodiment includes a linking portion 35, a disk portion 36, a breaking portion 37 and projected portions 38. The linking portion 35, which is fixed to the front end of the drive shaft 5, is formed in a substantially cylindrical shape so as to allow the front end of the drive shaft 5 to be inserted through the bottom thereof, and is fixed via its top by using a fastening piece such as a bolt. The disk portion 36 is formed in a substantially disk-like shape and ranges at a right angle from the outer wall surface of the linking portion 35. The disk portion is formed as an integrated part of the linking portion 35. The breaking portion 37 is constituted with a plurality of (3 in this example) slits formed at the disk portion 36 so that as a torque (moment) equal to or greater than a predetermined level is applied to the disk portion 36, the areas between the individual slits become broken off to break the linkage of the engine E and the drive shaft 5. The projected portions 38 are a plurality of (3 in this example) portions radially extending from the outer edge of the disk portion 36. The projected portions 38 are also each folded back along the direction moving away from the main body of the compressor 1 (along the upward direction in the figures).

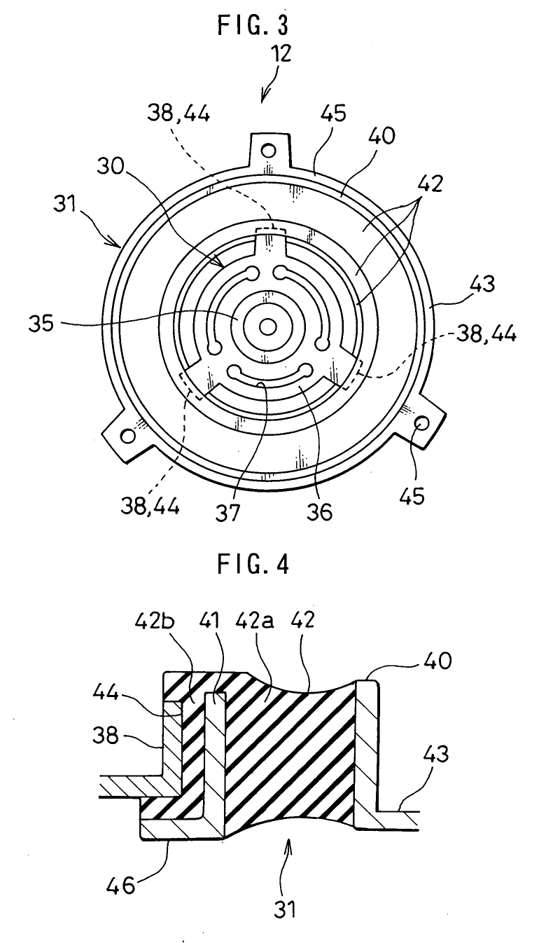

As shown in FIGS. 2 through 4, the damper unit 31 is constituted with an outer ring 40, an inner ring 41 and a rubber member 42. The outer ring 40 is a substantially cylindrical member constituting the outermost frame of the damper unit 31. It includes an edge portion 43 which ranges outward at the end thereof toward the compressor 1 (at the bottom in the figures) and rim fixing portions 45 to be fixed to a rim 23 (see FIG. 1) via specific fastening members formed are at the edge portion 43. The inner ring 41 is a substantially cylindrical member with the diameter thereof set smaller than that of the outer ring 40. It is disposed further inward relative to the outer ring 40, and includes an edge portion 46 ranging inward at the end thereof toward the compressor 1 (at the bottom in the figures). The rubber member 42 includes a portion 42a bonded with both the outer ring 40 and the inner ring 41 and filling the space between the outer ring 40 and the inner ring 41 and a portion 42b present on the inside of the inner ring 41. Indented portions 44 are formed at the portion 42b of the rubber member 42 located on the inside of the inner ring 41. The indented portions 44, which are to engage with the projected portions 38 of the hub unit 30 explained earlier, are formed in a shape, at positions and in a quantity matching those of the projected portions 38.

In the structure described above, the hub unit 30 and the damper unit 31 are initially manufactured as members independent of each other and later, the hub unit 30 and the damper unit 31 are integrated into a single damper assembly 12 by engaging the projected portion 38 and the indented portions 44 with each other. As a result, the need to strip the paint off the hub unit 30 as in the related art when bonding the rubber member 42 of the damper unit 31 is eliminated. Since the time wasting step no longer needs to be executed, the costs required when manufacturing the pulley 11 are reduced compared to the pulley manufacturing costs in the related art. In addition, the rubber member 42 is disposed so that it is also present on the inside of the inner ring 41 and the indented portions 44 constituting the engaging means at the damper unit 41 are formed at the portion 42b of the rubber member 42 located on the inside of the inner ring 41. This structure facilitates the assembly process with the elastic force of the rubber member 42 present around the indented portions 44 and improves the buffer effect of the entire damper assembly 12.

### Embodiment 2

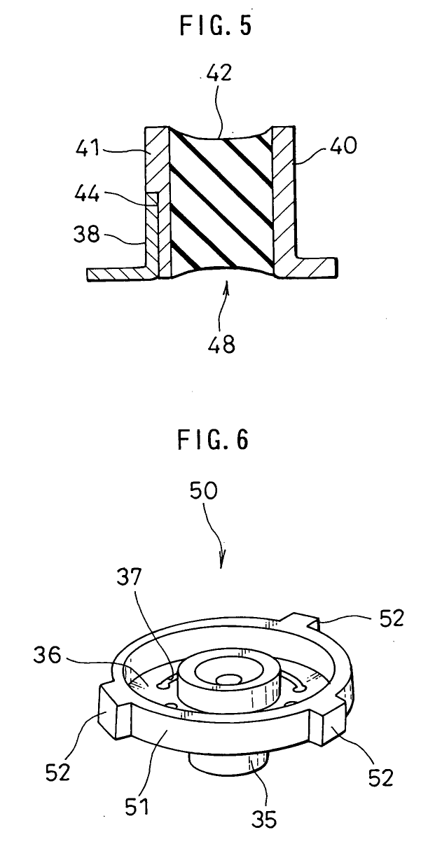

The pulley achieved in the embodiment includes a damper unit 48 adopting the structure shown in FIG. 5. In this damper unit 48, the rubber member 42 simply fills the space between the outer ring 40 and the inner ring 41, with the indented portions 44 constituting part of the engaging means formed at the inner ring 41. This structure, too, allows the time wasting manufacturing step to be eliminated when bonding the rubber member 42, thereby reducing the pulley manufacturing costs over the prior art.

### Embodiment 3

The pulley achieved in embodiment 3 includes a hub unit 50 adopting the structure shown in FIG. 6. The hub unit 50 includes a wall portion ranging upright from the outer edge of the disk portion 36, with projected portions 52 projecting outward formed at the wall portion 51. Advantages similar to those of embodiment 1 or embodiment 2 are also achieved by adopting the structure.

### Embodiment 4

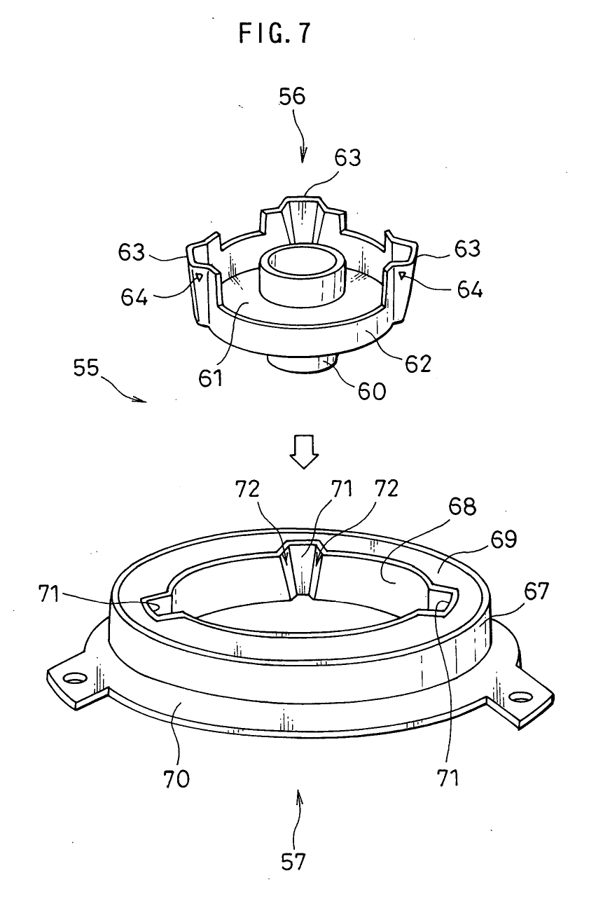

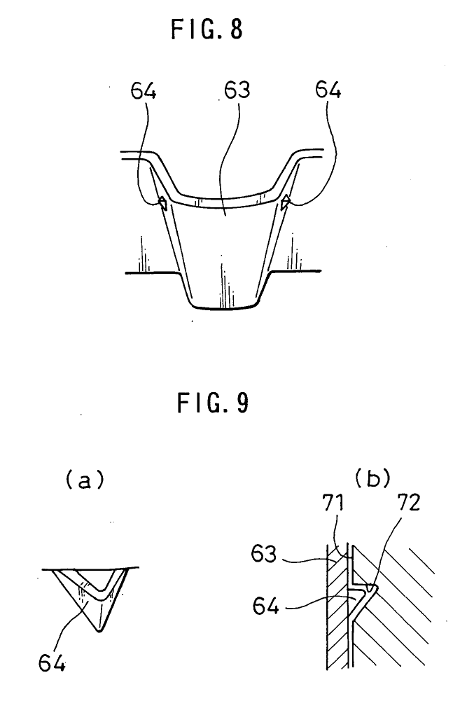

A damper assembly 55 achieved in embodiment 4 in FIG. 7 includes a hub unit 56 and a damper unit 57. A wall portion 62 ranging up right is formed at the outer edge of a disk portion 61 of the hub unit 56, with projecting outward formed at the wall portion 62 by bending or curving specific areas of the wall portion 62. The projected portions 63 assume a substantially trapezoidal shape, with the area of their sections taken along the horizontal direction gradually widening from the bottom to the top. A rubber member 69 of the damper unit 57 fills and is bonded at the space between the outer ring 67 and the inner ring 68, and indented portions 71 are formed in a shape that allows them to engage (fit) with the projected portions 61 at the inner ring 68. At the two side surfaces of each projected portion 63, a small projection 64 is formed as shown in FIG. 8. These small projections 64 are formed in a triangular cone shape, as shown in FIG. 9(a) so as to allow the small projections 64 to engage (fit) with small indentations 72 formed at the indented portions 72 at positions facing opposite the small projections 64, as shown in FIGS. 7 and 9(b).

This structure, too, allows the time wasting step to be eliminated when bonding the rubber member 69 as do the structures achieved in the other embodiments and thus, it becomes possible to lower the pulley manufacturing costs over the prior art. In addition, since the projected portions 63 are formed in a substantially trapezoidal shape with an inclination and includes the small projections 64 formed thereat, which facilitates the process of assembling the hub unit 56 and the damper unit 57 is facilitated and a reliable engagement of the hub unit and the damper unit is assured.

### Embodiment 5

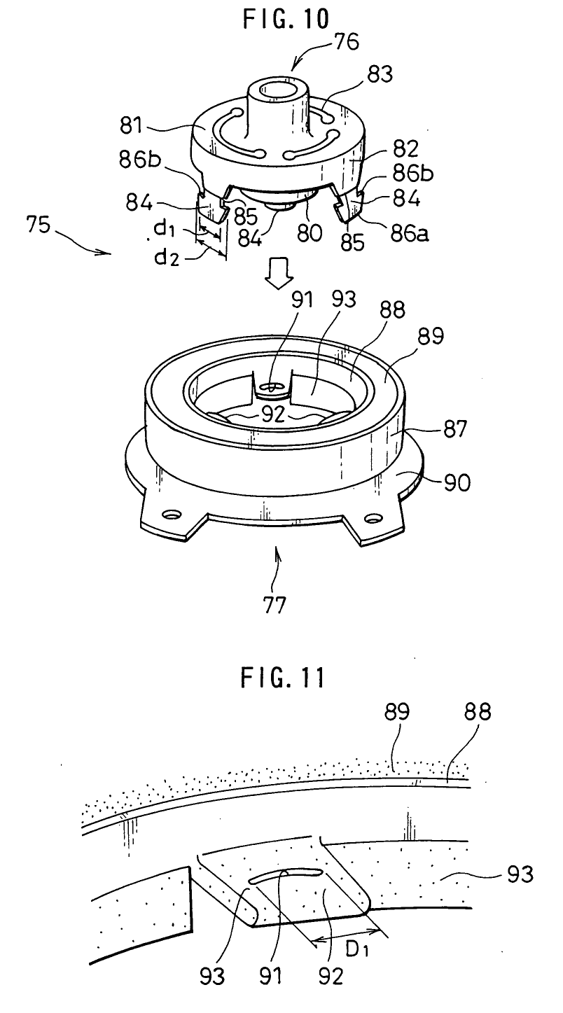

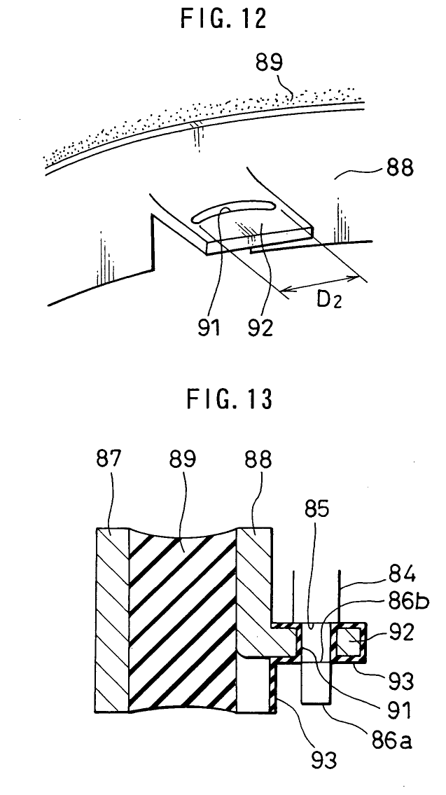

A damper assembly 75 achieved in embodiment 5 in FIG. 10 includes a hub unit 76 and a damper unit 77. A wall portion 82 ranging downward is formed at the outer edge of a disk portion 81 of the hub unit 76, with three projected portions 84 formed at the lower end of the wall portion 82 so as to range further downward. At each projected portion 84, a staged portion 85, a front end 86a and a wide portion 86b are formed. A rubber member 89 of the damper unit 77 fills and is bonded at the space between an outer ring 87 and an inner ring 88, tabs 92 are formed so as to range inward as shown in FIGS. 10 and 12 at the mer wall surface of the inner ring 88, a substantial lower half of the inner ring 88, including the tabs 92, is covered with a rubber film 93, as shown in FIG. 11, and a slit-like indented portion 91 is formed as each tab 92. It is to be noted that the inner ring 88 and the tabs 92 in FIG. 12 are not covered with the rubber film 93.

FIG. 13 shows how a projected portion 84 and the corresponding indented portion 91 are made to engage with each other in the structure described above. The staged portion 85 of the projected portion 84 is set in contact with the upper surface of the indented portion 91 and the wide portion 86b of the projected portion 84 is set in contact with the lower surface of the indented portion 91. In addition, with d1 representing the width of the front end 86a of the projected portion 84 (see FIG. 10), d2 representing the width of the wide portion 86b, d1 representing the width of the indented portion 91 at the tab covered with the rubber film 93 (see FIG. 11) and D2 representing the width of the indented portion 91 when the tab is not covered with the rubber film 93 (see FIG. 12), the relationships expressed as D1<D1 and d2>D2 exist. Thus, the projected portion 84 and the indented portion 91 can be engaged with each other by inserting the projected portion 84 so as to push through the rubber film 93 covering the areas around and inside the indented portion 91 until the staged portion 85 comes in contact with the upper surface of the tab 92. This embodiment, too, assures an easy and reliable assembly.

### Embodiment 6

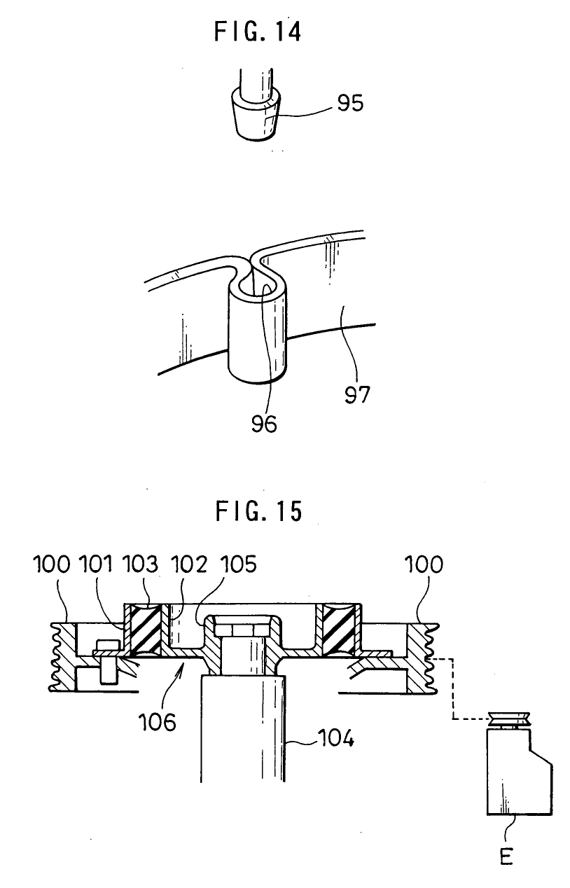

The damper assembly in embodiment 6 includes projected portions 95 and indented portions 96 such as those shown in FIG. 14. The projected portions 95 are formed with an elastic material such as rubber in the shape of a circular cone with a trapezoidal profile, whereas indented portions 96 are formed by curving an inner ring 97. By forming the projected portions and the indented portions in these shapes, too, they can be made to engage with each other with ease and reliability.

1. A pulley for a clutchless compressor, comprising:
a hub unit fixed to a drive shaft of said compressor,
a damper unit disposed between a member that rotates in response to a drive force imparted from a drive source and said hub unit to achieve a buffer effect via an elastic member thereof,
wherein said hub unit and said damper unit are formed as separate members independent of each other;
wherein said pulley includes an engaging means for engaging said hub unit and said damper unit to each other.

2. A pulley for a clutchless compressor, according to claim 1,
wherein said damper unit includes an outer ring fixed to said member which rotates in response to the drive force imparted from said drive source, an inner ring disposed further inward relative to said outer ring and said elastic member filling and bonded in the space between said outer ring and said inner ring.

3. A pulley for a clutchless compressor, according to claim 2,
wherein said engaging means is constituted with a projected portion and an indented portion formed at said hub unit and said inner ring to engage with each other.

4. A pulley for a clutchless compressor, according to claim 2,
wherein said elastic member is disposed so as to range over onto the inside of said inner ring.

5. A pulley for a clutchless compressor, according to claim 4,
wherein said engaging means is constituted with a projected portion and an indented portion formed at said hub unit and the portion of said elastic member present on the inside of said inner ring to engage with each other.

6. A pulley for a clutchless compressor, according to any of claims 1,
wherein a breaking portion that breaks at a torque equal to or greater than a predetermined level is formed at said hub unit.

7. A pulley for a clutchless compressor, according to any of claims 2,
wherein a breaking portion that breaks at a torque equal to or greater than a predetermined level is formed at said hub unit.

8. A pulley for a clutchless compressor, according to any of claims 3,
wherein a breaking portion that breaks at a torque equal to or greater than a predetermined level is formed at said hub unit.

9. A pulley for a clutchless compressor, according to any of claims 4,
wherein a breaking portion that breaks at a torque equal to or greater than a predetermined level is formed at said hub unit.

10. A pulley for a clutchless compressor, according to any of claims 5,
wherein a breaking portion that breaks at a torque equal to or greater than a predetermined level is formed at said hub unit.
